(19) United States
(12) Patent Application Publication
(10) Pub. No.: US 2021/0178623 A1
(43) Pub. Date: Jun. 17, 2021

(54) SHEET BUNDLE CUTTING APPARATUS AND BOOKBINDING APPARATUS

(71) Applicant: CANON FINETECH NISCA INC., Misato-shi, Saitama (JP)

(72) Inventor: Yuuki Kubota, Minamikoma-gun (JP)

(21) Appl. No.: 17/048,337

(22) PCT Filed: Apr. 18, 2019
(86) PCT No.: PCT/JP2019/016658

§ 371 Date: Oct. 16, 2020

(30) Foreign Application Priority Data
Apr. 20, 2018 (JP) 2018-081833
Apr. 11, 2019 (JP) 2019-075956

(51) Int. Cl. B26D 7/02; B42C 9/00; B42C 19/08; B26D 1/06; B26D 7/18

(52) U.S. Cl. CPC B26D 7/025; B42C 9/0006; B26D 2007/0018; B26D 1/06; B26D 7/1818; B42C 19/08

(57) ABSTRACT

A sheet bundle cutting apparatus includes a cutting portion (65) configured to cut, from a sheet bundle having one end bound with adhesive, a cutting scrap including a part of a spine of the sheet bundle, a pressure portion (59) configured to press the sheet bundle in a thickness direction while sandwiching a first surface and a second surface of the sheet bundle, and a bookbinding apparatus control CPU configured to control the pressure portion (59) and the cutting portion (65). The bookbinding apparatus control CPU causes the pressure portion (59) to press connection areas connected to the spine and respectively provided on the first surface and the second surface, and then causes the cutting portion (65) to cut the sheet bundle so that the cutting scrap includes a pressed area pressed by the pressure portion (59). Accordingly, it is possible to suppress spreading of the cutting scraps.

### TECHNICAL FIELD

The present invention relates to a sheet bundle cutting apparatus configured to cut an edge of a sheet bundle subjected to bookbinding, and to a bookbinding apparatus including the same.

### BACKGROUND ART

Hitherto, there are sheet bundle cutting apparatus configured to cut and trim an edge of a sheet bundle subjected to bookbinding (PTL 1 and PTL 2). In each of those sheet bundle cutting apparatus, a cutting scrap generated when the edge of the sheet bundle subjected to bookbinding is cut is contained in a cutting scrap container.

### CITATION LIST

### Patent Literature

PTL 1: Japanese Patent Application Laid-Open No. 2005-305822

PTL 2: Japanese Patent Application Laid-Open No. 2015-217494

### SUMMARY OF INVENTION

### Technical Problem

However, in the related-art sheet bundle cutting apparatus, when a cutting scrap is caused to fall and contained in the cutting scrap container, the cutting scrap sometimes falls into the cutting scrap container with its unbound portion spreading (see FIG. 10B). This is because a cover sheet is opened outward with a lapse of time after the binding is performed. When the cutting scrap is opened in this manner, the cutting scrap may be caught in the cutting scrap container or may become bulky inside the cutting scrap container, to thereby lead to a problem in that a cutting scrap containing efficiency of the cutting scrap container may deteriorate.

The present invention provides a sheet bundle cutting apparatus configured to suppress spreading of a cutting scrap of a sheet bundle and a bookbinding apparatus including this sheet bundle cutting apparatus.

### Solution to Problem

According to the present invention, there is provided a sheet bundle cutting apparatus configured to cut a sheet bundle including a bound spine, the sheet bundle cutting apparatus comprising: pressure means for pressing the sheet bundle in a thickness direction of the sheet bundle while sandwiching a first surface and a second surface of the sheet bundle; cutting means for cutting, from the sheet bundle, a cutting scrap including a part of the spine; control means for controlling the pressure means and the cutting means, the control means being configured to cause the pressure means to press connection areas connected to the spine, which are respectively provided on the first surface and the second surface, and then cause the cutting means to cut the sheet bundle so that the cutting scrap includes a pressed area pressed by the pressure means; and containing means for containing the cutting scrap.

### Advantageous Effects of Invention

According to the present invention, it is possible to suppress the spreading of the cutting scrap of the sheet bundle, thereby being capable of improving the cutting scrap containing efficiency of the cutting scrap container.

According to the present invention, the sheet bundle cutting apparatus having a high cutting scrap containing efficiency is provided, and hence the availability ratio of the bookbinding apparatus can be increased.

### BRIEF DESCRIPTION OF DRAWINGS

FIG. 1 is a schematic sectional view for illustrating an image forming system including a bookbinding apparatus according to an embodiment of the present invention taken along a sheet conveyance direction.

FIG. 2 is a schematic sectional view for illustrating the bookbinding apparatus according to the embodiment of the present invention taken along a sheet conveyance direction.

FIG. 3 is a view for illustrating a cover sheet binding portion, a sheet bundle conveyance portion, a bundle attitude changing portion, a cutting portion, and a cutting scrap containing portion which are included in the bookbinding apparatus.

FIG. 4 is a control block diagram for illustrating an image forming apparatus and the bookbinding apparatus.

FIG. 5 is a flowchart of a bookbinding operation of the bookbinding apparatus.

FIG. 6 is a derived flowchart of the bookbinding operation of the bookbinding apparatus.

FIG. 7 is a flowchart of a cutting operation of the bookbinding apparatus according to a first embodiment.

FIG. 8 is a flowchart of a cutting operation of a bookbinding apparatus according to a second embodiment.

FIG. 9A is a view for illustrating a cutting line and a pressed area of a sheet bundle covered with a cover sheet in the first embodiment.

FIG. 9B is a view for illustrating a cutting line and a pressed area of a sheet bundle covered with a cover sheet in the second embodiment.

FIG. 10A is a perspective view of a cut sheet bundle covered with the cover sheet and its cutting scrap.

FIG. 10B is a perspective view of the cutting scrap in a spreading state.

### DESCRIPTION OF EMBODIMENTS

### First Embodiment

Now, with reference to the drawings, description is made of an image forming system which includes a bookbinding apparatus according to a first embodiment of the present invention.

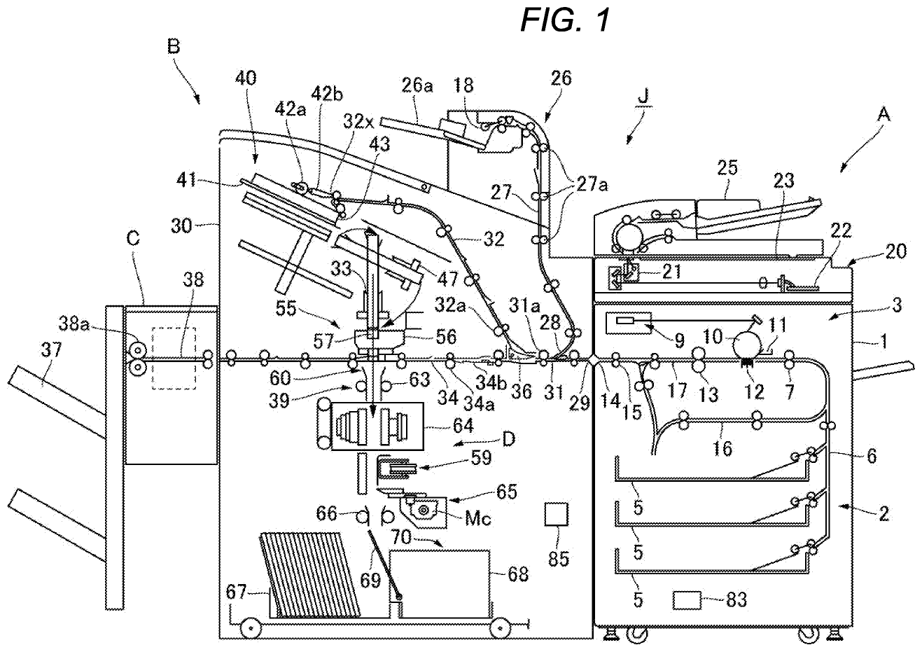

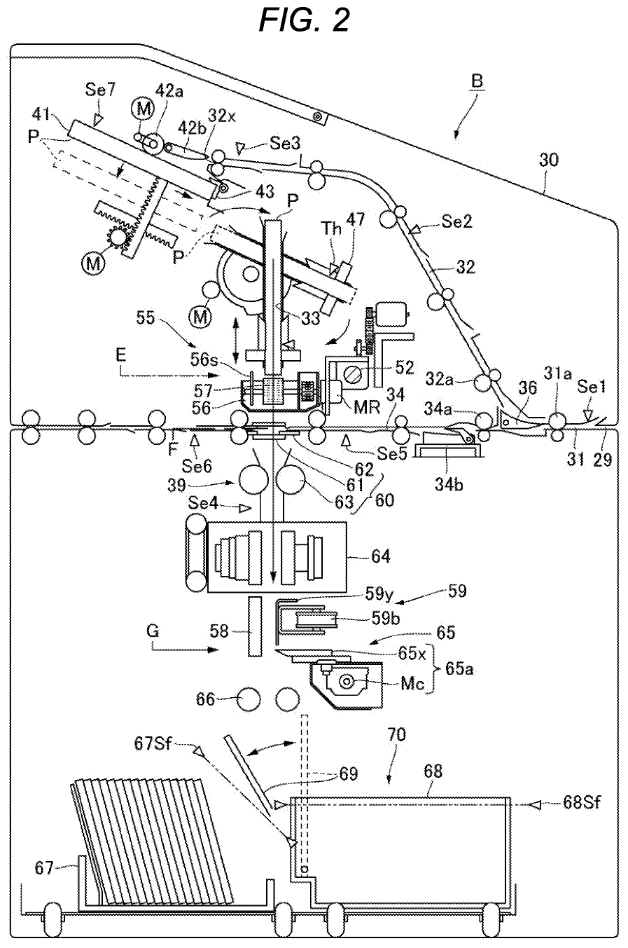

FIG. 1 is a schematic sectional view for illustrating an image forming system J including a bookbinding apparatus B according to the first embodiment of the present invention taken along a sheet conveyance direction. FIG. 2 is a schematic sectional view for illustrating the bookbinding apparatus B according to the first embodiment of the present invention taken along a sheet conveyance direction.

The image forming system J includes an image forming apparatus A, the bookbinding apparatus B, and a post-processing apparatus C. The image forming apparatus A is configured to sequentially form toner images on sheets. The bookbinding apparatus B is arranged on a downstream side of the image forming apparatus A. The post-processing apparatus C is arranged on downstream of this bookbinding apparatus B. The image forming system J uses the bookbinding apparatus B to perform bookbinding processing on the sheets having been subjected to image formation in the image forming apparatus A. Further, the image forming system J allows sheets which are not subjected to the bookbinding processing to pass through the bookbinding apparatus B, uses the post-processing apparatus C to perform post-processing on the sheets, and discharges the sheets.

[Image Forming Apparatus A]

The image forming apparatus A is configured to form images on sheets. Examples of the image forming apparatus A may include those of various structures such as a copying machine, a printer, and a printing machine. The image forming apparatus A in this embodiment is a copying machine configured to form toner images on sheets. The image forming apparatus A includes, in an apparatus main body 1 thereof, a sheet supply portion 2, a printing portion 3, a sheet discharging port 14, and an image forming apparatus control CPU 83. In the sheet supply portion 2, a plurality of cassettes 5 corresponding to respective sheet sizes are arrayed in an up-and-down direction. The sheet supply portion 2 sends out a sheet having a size designated by the image forming apparatus control CPU 83 to a feed passage 6. In the feed passage 6, a registration roller pair 7 is provided. The registration roller pair 7 aligns a leading end of the sheets, and feeds the sheet to the printing portion 3 on the downstream side at a predetermined timing.

The printing portion 3 includes an electrostatic drum (photosensitive drum) 10. In a periphery of the electrostatic drum 10, there are provided a print head 9, a developing device 11, and a transfer charger 12. The print head 9 is formed of, for example, a laser emitter, and is configured to form an electrostatic latent image on the electrostatic drum 10. The electrostatic latent image is developed with toner by the developing device 11 to be formed into a toner image, and the toner image is transferred onto a sheet by the transfer charger 12. The sheet has the toner image fixed thereto by a fixing device 13 to be delivered to a sheet discharging passage 17. A sheet discharging roller pair 15 is arranged at the sheet discharging port 14. In a circulation passage 16, the sheet conveyed from the sheet discharging passage 17 is reversed front and back in a switchback passage, and thereafter is guided to the registration roller pair 7 again. The printing portion 3 forms a toner image on a back surface of the sheet that has been conveyed along the circulation passage 16. In such a manner, the sheet having the toner image formed on one side or both sides is conveyed from the sheet discharging port 14 to the bookbinding apparatus B.

A scanner unit 20 provided on top of the apparatus main body 1 is configured to optically read an image of an original. As generally known, the scanner unit 20 includes a platen glass 23, a carriage 21, and an optical reading means (for example, CCD device) 22. The platen glass 23 is configured to receive an original to be placed thereon by a user. The carriage 21 is configured to optically read an original along the platen glass 23. The optical reading means 22 is configured to perform photoelectric conversion on an optical image transmitted from the carriage 21. Further, the scanner unit 20 includes, on top thereof, an original feeder 25 configured to automatically feed an original to the platen glass 23.

[Bookbinding Apparatus B]

FIG. 2 is a schematic sectional view for illustrating the bookbinding apparatus B taken along the sheet conveyance direction. The bookbinding apparatus B is arranged to be connected to the image forming apparatus A.

In the following description, a sheet which serves as a cover sheet of a sheet bundle is referred to as “cover sheet”. A sheet covered with the cover sheet (sheet for the body) is referred to as “inner sheet”. A bundle of inner sheets is referred to as “inner sheet bundle”. The inner sheet bundle covered with the cover sheet is referred to as “sheet bundle covered with the cover sheet”. A sheet bundle covered with the cover sheet which has been trimmed is referred to as “booklet”. Those sheet bundles are simply referred to as “sheet bundle” in some parts.

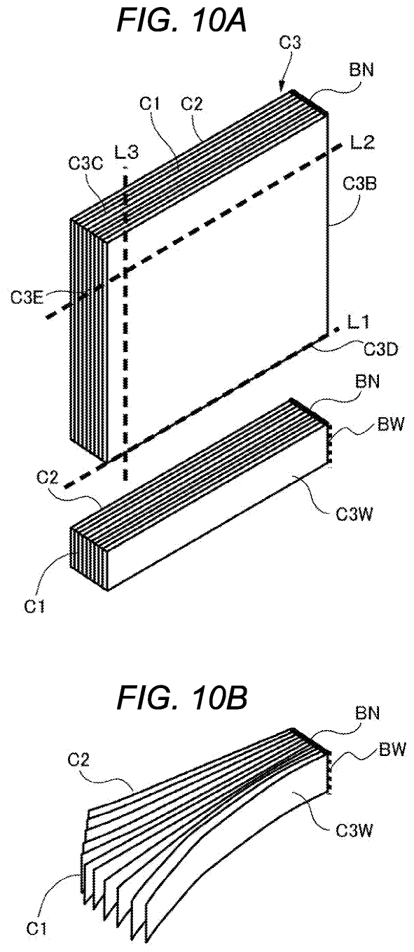

As illustrated in FIG. 10A, a sheet bundle C3 covered with a cover sheet is formed by binding an inner sheet bundle C1 at an end surface (spine) of its edge bound through application of an adhesive BN and covering the inner sheet bundle C1 with a cover sheet C2. The cover sheet C2 is pasted to the inner sheet bundle C1 with the adhesive BN. The bookbinding apparatus B according to this embodiment has a function of suppressing a cutting scrap C3W, which is cut from the sheet bundle C3 covered with the cover sheet and includes a portion (part of the spine) to which the adhesive BN is applied, from spreading as illustrated in FIG. 10B.

As illustrated in FIG. 1, the bookbinding apparatus B includes the following components. That is, the bookbinding apparatus B includes: a casing 30; a stacking portion 40 configured to stack sheets having toner images formed thereon into a bundle and then align the bundle; an adhesive applying portion 55 configured to apply an adhesive, for example, paste or glue, to the inner sheet bundle conveyed from the stacking portion 40; a cover sheet binding portion 60 configured to bind a cover sheet on the inner sheet bundle having the adhesive applied thereto; a bundle attitude changing portion 64 configured to change an orientation of a sheet bundle covered with a cover sheet; a pressure portion 59 configured to press one end of the sheet bundle covered with the cover sheet at which the sheet bundle is bound with the adhesive or an edge (cut edge) of the sheet bundle at which the sheet bundle is to be cut; a cutting portion 65 configured to perform trimming cut on the edge (cut edge) of the sheet bundle covered with the cover sheet having been changed in orientation; a cutting scrap containing portion 70 configured to accommodate the cutting scrap generated during the trimming cut; and a containing stacker 67 configured to accommodate a booklet formed through the trimming cut.

[Configuration of Conveyance Passage]

Description is made of each conveyance passage for the sheets with reference to FIG. 1. In the casing 30, there is provided a carry-in passage 31 having a carry-in port 29 which continues from the sheet discharge port 14 of the image forming apparatus A. The carry-in passage 31 is connected to an inner sheet conveyance passage 32 and a cover sheet conveyance passage 34 through intermediation of a passage switching member 36. The inner sheet conveyance passage 32 is connected to a bookbinding passage 33 through intermediation of the stacking portion 40. The cover sheet conveyance passage 34 is connected to a post-processing passage 38 of the post-processing apparatus C. The bookbinding passage 33 extends vertically through the bookbinding apparatus B in a substantially vertical direction. The cover sheet conveyance passage 34 extends horizontally through the bookbinding apparatus B in a substantially horizontal direction. Therefore, the bookbinding passage 33 and the cover sheet conveyance passage 34 cross each other (are orthogonal to each other), and the cover sheet binding portion 60 described later is arranged at the crossing part.

With the configuration of the conveyance passages as described above, the carry-in passage 31 receives, from the image forming apparatus A, sheets (inner sheets) having toner images formed thereon. In addition, the carry-in passage 31 receives a print sheet (cover sheet), which is to be used as a cover sheet and has a title and the like printed thereon, from the image forming apparatus A. The passage switching member 36 sets a passage to be passed by the sheet to the inner sheet conveyance passage 32 or the cover sheet conveyance passage 34.

Moreover, an inserter apparatus 26 is connected to the carry-in passage 31. The inserter apparatus 26 is configured to feed cover sheets, which are not subjected to printing in the image forming apparatus A, one after another from a sheet feeding tray 26a to the carry-in passage 31. The inserter apparatus 26 includes one or a plurality of sheet feeding trays 26a, a cover sheet feeding portion 18, and a cover sheet feeding passage 27. The cover sheet feeding portion 18 is configured to separate and feed one after another cover sheet stacked on the sheet feeding tray 26a at its distal end portion. The cover sheet feeding passage 27 is provided on a downstream side of the cover sheet feeding portion 18. The cover sheet feeding passage 27 is connected to the carry-in passage 31 through intermediation of a passage switching member 28. A conveyance roller pair 31a is arranged on the carry-in passage 31. A conveyance roller pair 32a is arranged on the inner sheet conveyance passage 32. On the bookbinding passage 33, there are provided a grip conveyance portion 47, the bundle attitude changing portion 64 described later, and a booklet discharging roller pair 66. A conveyance roller pair 34a is arranged on the cover sheet conveyance passage 34, and a discharge roller pair 38a is arranged on the post-processing passage 38. Further, as a drive source, a drive motor (not shown) is coupled to each of the conveyance roller pair 34a and the discharge roller pair 38a.

[Stacking Portion 40]

The stacking portion 40 is described with reference to FIG. 2. A stack tray 41 arranged at an inner sheet discharging port 32x of the inner sheet conveyance passage 32 is configured to stack and accommodate the inner sheets, which have been discharged from the inner sheet discharging port 32x, in a bundle shape. The stack tray 41 is formed of a tray member arranged in a substantially horizontal attitude. There are arranged a forward/reverse rotation roller 42a and a carry-in guide 42b above the stack tray 41. Then, the inner sheets having been discharged from the inner sheet discharging port 32x are guided to a position above the stack tray 41 by the carry-in guide 42b, and are stacked on the stack tray 41 by the forward/reverse rotation roller 42a. The forward/reverse rotation roller 42a performs forward rotation to deliver the inner sheets toward a distal end side of the stack tray 41, and performs reverse rotation to bring a trailing edge of the inner sheets into abutment with a regulation member 43 arranged at a tray rear end (right end in FIG. 2), to thereby regulate the inner sheets. A pair of sheet side alignment plates (not shown) are provided to the stack tray 41, and the sheet side alignment plates align both side edges of the inner sheets stacked on the stack tray 41. With such a configuration, the inner sheets having been delivered from the inner sheet conveyance passage 32 are sequentially stacked on the stack tray 41, and then are aligned into a bundle shape.

[Sheet Bundle Conveyance Portion 39]

In FIG. 2, a sheet bundle conveyance portion 39 is arranged on the bookbinding passage 33. The sheet bundle conveyance portion 39 includes the grip conveyance portion 47, a folding roller pair 63, and the booklet discharging roller pair 66. The sheet bundle conveyance portion 39 conveys the sheet bundle from the stack tray 41 to an “adhesive applying position E”, a “cover sheet binding position F”, and a “cutting position G” in the stated order, and discharges the sheet bundle to the containing stacker 67.

The grip conveyance portion 47 is formed of a pair of nip members. The grip conveyance portion 47 is configured to grip the inner sheet bundle stacked on the stack tray 41, and rotate the inner sheet bundle by 90 degrees to change its attitude. Thus, the grip conveyance portion 47 is rotatably equipped with respect to the casing 30. The grip conveyance portion 47 changes the inner sheet bundle stacked on the stack tray 41 from a horizontal attitude to a vertical attitude, and sets the inner sheet bundle at the adhesive applying position E so that the inner sheet bundle is to be conveyed along the bookbinding passage 33 arranged so as to extend in a substantially vertical direction. Thus, the stack tray 41 is lowered from a stacked position (solid line in FIG. 2) to a delivery position (broken line in FIG. 2), and delivers the sheet bundle to the grip conveyance portion 47 prepared at this delivery position.

The folding roller pair 63 is formed of a pair of rollers, and is configured to fold the cover sheet of the sheet bundle covered with the cover sheet simultaneously with the conveyance of the sheet bundle covered with the cover sheet from the cover sheet binding position F to the cutting position G on a downstream side. The booklet discharging roller pair 66 is also formed of a pair of rollers, and is configured to convey the sheet bundle to the containing stacker 67 on the downstream side. The bundle attitude changing portion 64 is provided between the folding roller pair 63 and the cutting position G. The bundle attitude changing portion 64 also forms a sheet bundle conveyance portion, which is described later in detail.

[Bundle Thickness Detection Portion]

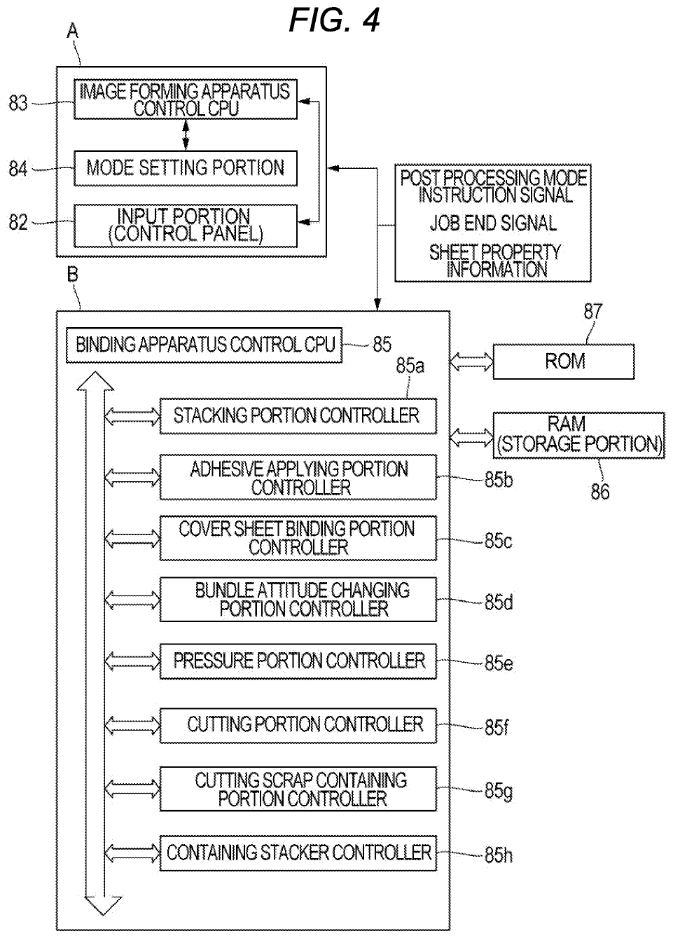

The following methods are available as a method of detecting a thickness of the inner sheet bundle. A first method is a method of arranging a sheet discharging sensor Se3 (FIG. 2) at an inner sheet discharging port 32x of the inner sheet conveyance passage 32 to detect the thickness. The sheet discharging sensor Se3 is configured to count the number of conveyed inner sheets, and to calculate the thickness of the inner sheet bundle from a known average thickness of the inner sheets. For example, a counter is provided to a bookbinding apparatus control CPU 85 (FIG. 4), which is described later, to count sheet discharge signals from the sheet discharging sensor Se3 during a period between a sheet discharge instruction signal and a job end signal, which are received from the image forming apparatus A, and to multiply the counted value by the thickness of an inner sheet set in advance. In this manner, the configuration is simplified when the thickness of the inner sheet bundle is calculated from the number of discharged sheets detected by the sheet discharging sensor Se3. However, the thickness of the inner sheet bundle detected by the first method has an approximate value obtained through calculation.

A second method is a method of using a slidac sensor Se7 in abutment with an uppermost inner sheet of the inner sheets stacked on the stack tray 41. The thickness of the inner sheet bundle is detected through detection of the position of the slidac sensor Se7. For example, a lever member in contact with the uppermost inner sheet is movably arranged on a stack tray in a stacking direction, and the slidac sensor Se7 is used to detect the position of this lever member.

A third method is a method of using a slidac sensor Th, with the grip conveyance portion 47 being formed of a fixed gripper and a movable gripper, to detect a position at which the movable gripper is in abutment with a surface of the inner sheet.

The thickness of the inner sheet bundle can be detected by any one of the first method, the second method, and the third method. However, in order to detect the thickness of the inner sheet bundle with higher accuracy, it is preferred to use the second method, that is, the slidac sensor Se7.

The thickness of the inner sheet bundle detected by any one of the methods is used for subsequent control. For example, when an adhesive is applied to the inner sheet bundle by the adhesive applying portion 55 described later, an amount of the adhesive to be applied is adjusted according to a bundle thickness.

[Adhesive Applying Portion 55]

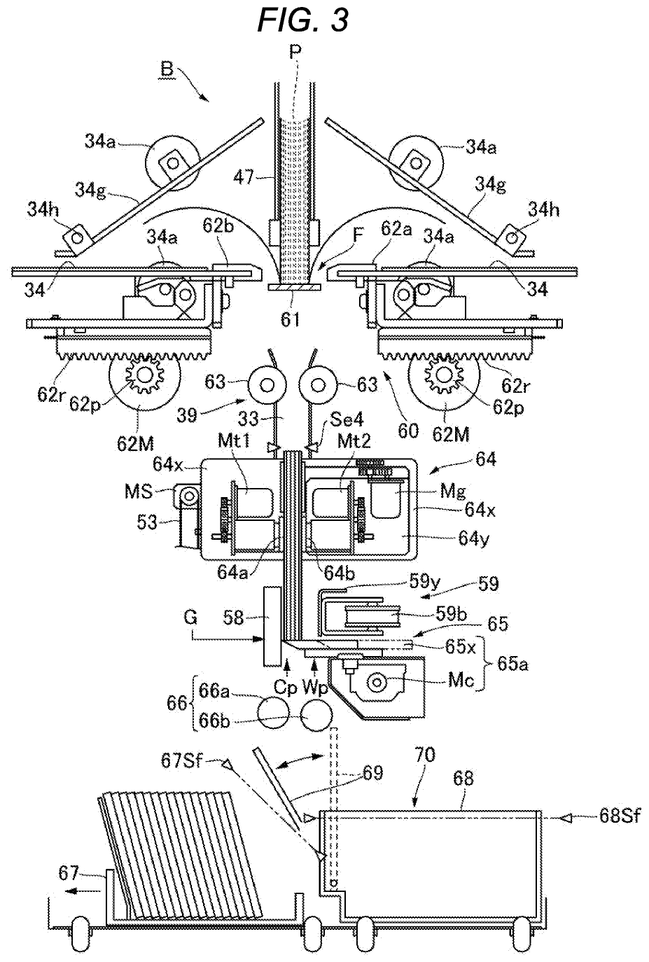

FIG. 3 is a view for illustrating the cover sheet binding portion 60, the sheet bundle conveyance portion 39, the bundle attitude changing portion 64, the cutting portion 65, and the cutting scrap containing portion 70 which are included in the bookbinding apparatus B. In FIG. 1 and FIG. 2, the adhesive applying portion 55 is arranged at the adhesive applying position E of the bookbinding passage 33 as adhesive applying means. The adhesive applying portion 55 includes an adhesive container 56, an applying roll 57, and a roll rotation motor MR. The adhesive container 56 is configured to accommodate a thermally meltable adhesive.

An adhesive sensor 56s (FIG. 2) configured to detect a remaining amount of the adhesive is provided in the adhesive container 56. The adhesive sensor 56s serves also as a temperature sensor configured to detect a temperature of the adhesive. The adhesive sensor 56s is configured to detect a temperature of the liquefied adhesive in the adhesive container 56. The adhesive sensor 56s is also configured to detect a remaining amount of the adhesive based on a difference in temperature between a part that is soaked in the adhesive and a part that is not soaked in the adhesive. Then, the adhesive container 56 is caused to reciprocate along the sheet bundle from a home position with a predetermined stroke, and in the process of the reciprocating movement, the adhesive is applied to the edge (one end) of the sheet bundle by the applying roll 57 in the adhesive container 56. The applying roll 57 is formed of a heat-resistant porous material, and is configured to allow glue to be impregnated thereinto to thereby form a layer of the glue on a periphery of the roll.

[Cover Sheet Binding Portion 60]

The cover sheet binding portion 60 is arranged at the cover sheet binding position F on the bookbinding passage 33. As illustrated in FIG. 3, the cover sheet binding portion 60 is formed of an abutment plate 61, folding plates 62 (62a and 62b), and a folding roller pair 63. The cover sheet conveyance passage 34 is arranged at the cover sheet binding position F (FIG. 2), and a cover sheet is fed from the image forming apparatus A or the inserter apparatus 26.

The abutment plate 61 is a plate-shaped member configured to hold the cover sheet from the back (support the cover sheet). The abutment plate 61 supports the cover sheet when the cover sheet delivered from the cover sheet conveyance passage 34 and the inner sheet bundle delivered from the bookbinding passage 33 are joined to each other. The abutment plate 61 also has a function of cooling a bound portion of the sheet bundle to which the cover sheet has been bonded. The abutment plate 61 is arranged so as to be movable along the bookbinding passage 33. When the sheet bundle covered with the cover sheet moves to the cutting position G on the downstream side, the abutment plate 61 is caused to retreat from a path of the sheet bundle covered with the cover sheet.

The folding plates 62 are arranged on upstream of the abutment plate 61, and are configured to fold the cover sheet supported by the abutment plate 61. Thus, the folding plates 62 are arranged in a pair (62a and 62b) on right and left sides of the bookbinding passage 33, and are configured to be able to approach and separate from each other. The right and left folding plates 62a and 62b are each coupled to an actuating motor 62M serving as a drive source through intermediation of a rack gear 62r and a transmission pinion 62p.

Thus, when the right and left actuating motors 62M are rotated by the same amount, pressure surfaces of the folding plates 62a and 62b bend a bound portion of the cover sheet to form a spine of a book. The cover sheet conveyance passage 34 illustrated in FIG. 3 includes the conveyance roller pair 34a. In addition, upper guides 34g forming the cover sheet conveyance passage 34 are caused to swing in an up-and-down direction together with the conveyance roller pair 34a about rotary shafts 34h to open and close an upper side of the bookbinding passage 33.

The cover sheet fed to the cover sheet conveyance passage 34 by the abutment plate 61 and the folding plates 62 is supported by the abutment plate 61. The inner sheet bundle delivered from the bookbinding passage 33 by the grip conveyance portion 47 is brought into abutment on the cover sheet to be joined to the cover sheet. After this joining, the folding plates 62 are brought closer to each other from separate positions illustrated in FIG. 3. Then, the cover sheet is folded so as to sandwich the inner sheet bundle to form a spine of a book. The folding roller pair 63 is arranged on the downstream side of the abutment plate 61. The folding roller pair 63 is a pair of rollers held in pressure contact with each other. Although not shown, one of the rollers is moved in a direction perpendicular to a conveyance direction according to the thickness of the sheet bundle.

The bookbinding apparatus B according to this embodiment has a feature in that, at the cutting position G, the sheet bundle covered with the cover sheet is pressed against a receiving member 58 by a pressing member 59y. Its configuration and operation are described later.

[Sheet Bundle Cutting Apparatus D]

A sheet bundle cutting apparatus D illustrated in FIG. 1 is configured to cut the cut edge of the sheet bundle covered with a cover sheet. The sheet bundle cutting apparatus D includes the bundle attitude changing portion 64, the pressure portion 59, and the cutting portion 65.

[Bundle Attitude Changing Portion 64]

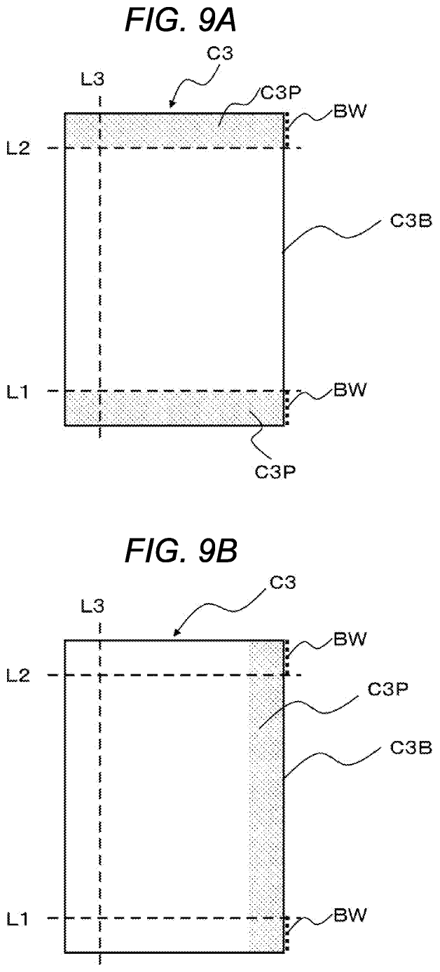

The bundle attitude changing portion 64 is described with reference to FIG. 3, FIG. 9A, and FIG. 9B. The bundle attitude changing portion 64 serving as moving/rotating means for changing the orientation of the sheet bundle and the cutting portion 65 serving as cutting means for cutting a peripheral edge of the sheet bundle are arranged on the downstream side of the folding roller pair 63. The bundle attitude changing portion 64 is configured to feed the sheet bundle having been subjected to the joining of the cover sheet at the cover sheet binding position F to the cutting position G on the downstream side in an attitude in a predetermined orientation. The cutting portion 65 is configured to cut an end portion of the sheet bundle at the cutting position G to adjust a shape of its cross section.

The bundle attitude changing portion 64 includes rotation tables 64a and 64b. The rotation tables 64a and 64b are configured to sandwich and hold the sheet bundle covered with the cover sheet delivered from the folding roller pair 63 in a thickness direction. The rotation tables 64a and 64b are configured to subsequently rotate the sheet bundle covered with the cover sheet about a normal direction of the surface of the sheet bundle serving as a rotary axis. As illustrated in FIG. 3, the rotation tables 64a and 64b are provided on a unit frame 64x. The unit frame 64x can be raised and lowered with respect to the casing 30.

The unit frame 64x is configured to rotatably support each of a pair of rotation tables 64a and 64b with the bookbinding passage 33 interposed therebetween. The rotation table 64b can move in a sheet bundle thickness direction (direction perpendicular to the bookbinding passage 33). The rotation tables 64a and 64b include motors Mt1 and Mt2 as drive sources for changing the attitude of the sheet bundle in the bookbinding passage 33. In addition, the rotation table 64b includes a grip motor Mg for movement in a horizontal direction illustrated in FIG. 3.

The sheet bundle C3 covered with the cover sheet guided into the bookbinding passage 33 is conveyed by the folding roller pair 63 with a spine C3B bound with the adhesive facing down. Then, the sheet bundle C3 covered with the cover sheet is held by a pair of left and right rotation tables 64a and 64b, and has the attitude changed by the motors Mt1 and Mt2.

When the peripheral edges in three directions other than the spine are cut (subjected to the trimming cut), the sheet bundle C3 covered with the cover sheet is set to have cutting lines L1, L2, and L3 illustrated in FIG. 9A at the cutting position G, and the cutting portion 65 cuts the sheet bundle C3 covered with the cover sheet along each of the cutting lines L1, L2, and L3. In this embodiment, cutting lines for cutting the cutting scraps including parts of the spine C3B of the sheet bundle C3 covered with the cover sheet are set as L1 and L2, and a cutting line for cutting the opposite side of the spine C3B is set as L3.

In addition, a grip sensor (not shown) is provided to the rotation table 64b on a movable side. The rotation tables 64a and 64b start to be rotated after the grip sensor has detected that the sheet bundle C3 covered with the cover sheet is firmly held. Then, the unit frame 64x moves the sheet bundle along the bookbinding passage 33 by an elevation motor MS.

At a time of three-way trimming, the sheet bundle C3 covered with the cover sheet is repeatedly set at the cutting position G by the bundle attitude changing portion 64 and cut by the cutting portion 65 in order of the cutting lines L1, L2, and L3. At a time of two-way trimming, the sheet bundle C3 covered with the cover sheet is repeatedly set at the cutting position G and cut in order of the cutting lines L1 and L2. At a time of one-way trimming, the sheet bundle C3 covered with the cover sheet has the cutting line L3 set at the cutting position G and cut.

[Pressure Portion 59]

As illustrated in FIG. 2 and FIG. 3, the pressure portion 59 serving as pressure means includes a cut edge pressing unit 59b and the receiving member 58. The cut edge pressing unit 59b includes the pressing member 59y and a motor (not shown) configured to cause the pressing member 59y to approach and separate from the receiving member 58. The pressing member 59y is moved by the motor (not shown) to press the sheet bundle C3 covered with the cover sheet against the receiving member 58 from its thickness direction. In other words, the pressure portion 59 presses the sheet bundle C3 covered with the cover sheet in its thickness direction while sandwiching a first surface and a second surface of the sheet bundle C3 covered with the cover sheet by the pressing member 59y and the receiving member 58. The receiving member 58 is a plate-shaped member and has a length in the up-and-down direction so as to be opposed to the pressing member 59y and a cutting blade 65x described later. The receiving member 58 is formed so as to withstand a pressing force applied from the pressing member 59y and the cutting blade 65x.

The pressure portion 59 configured in this manner uses the pressing member 59y and the receiving member 58 to press one end (spine) of the sheet bundle C3 covered with the cover sheet at which the sheet bundle C3 is bound with the adhesive or the edge (cut edge) of the sheet bundle C3 covered with the cover sheet at which the sheet bundle is to be cut.

[Cutting Portion 65]

As illustrated in FIG. 2 and FIG. 3, the cutting portion 65 serving as the cutting means includes the cut edge pressing unit 59b, the cutting blade unit 65a, and the receiving member 58. The cut edge pressing unit 59b and the receiving member 58 have already been described in the section regarding the pressure portion 59, and hence description thereof is omitted. The cutting blade unit 65a includes the cutting blade 65x and a cutter motor MC. The cutting blade 65x has a flat blade shape. The cutter motor MC is configured to cause the cutting blade 65x to approach and separate from the receiving member 58. The cutting portion 65 uses the pressing member 59y to cause the edge (cut edge) of the sheet bundle covered with the cover sheet at which the sheet bundle is to be cut to be pressed against the receiving member 58. After that, the cutting portion 65 uses the cutting blade 65x to cut and trim a predetermined amount of the peripheral edge (cut edge) excluding the spine of the sheet bundle covered with the cover sheet. Then, the peripheral edge of the cut sheet bundle is discharged as a cutting scrap.

The booklet discharging roller pair 66 and the containing stacker 67 are arranged on the downstream side of the cutting position G. As illustrated in FIG. 3, the containing stacker 67 is configured to accommodate the sheet bundle in an upright attitude. The booklet discharging roller pair 66 is arranged on the downstream side of the cutting position G, and is configured to convey the sheet bundle to the containing stacker 67. The booklet discharging roller pair 66 is formed of a pair of rollers 66a and 66b. The roller 66b is configured to move in a sheet width direction according to the thickness of the sheet bundle to change a position for nipping the sheet bundle.

The containing stacker 67 is also enabled to be pulled out from the casing 30. The user can pull out the containing stacker 67 toward a front side of the image forming apparatus A (front side of the drawing sheet of FIG. 1) to take out the sheet bundle from above the containing stacker 67. The sheet bundle full sensor 67Sf is configured to detect a fully-filled state of sheet bundles contained in the containing stacker 67 and urge an operator to remove the sheet bundles.

[Cutting Scrap Containing Portion 70]

The cutting scrap containing portion 70 serving as a containing means for containing a cutting scrap is provided below the cutting position G in parallel with the containing stacker 67. The cutting scrap containing portion 70 includes a cutting scrap container 68, a sweeper portion 69, and a full sensor 68Sf. The cutting scrap container 68 is arranged in parallel with the containing stacker 67. The cutting scrap container 68 is configured to accommodate a cutting scrap cut by the cutting blade 65x. The sweeper portion 69 is provided immediately below the cutting position G. The sweeper portion 69 is configured to swing along a left-and-right direction indicated by the solid line and the broken line in FIG. 2 by a drive motor (not shown). The sweeper portion 69 is also configured to guide the cutting scrap to the cutting scrap container 68 while waiting at a position indicated by the solid line immediately below the cutting position G when the sheet bundle is cut, and after the sheet bundle is cut, retreat from the cutting position G to a position indicated by the broken line to guide the sheet bundle to the containing stacker 67. In addition, the full sensor 68Sf configured to detect a containing amount of cutting scraps contained inside is arranged for the cutting scrap container 68.

The cutting scrap C3W contained in the cutting scrap containing portion 70 is described with reference to FIG. 10A and FIG. 10B. In FIG. 10A, the cutting scrap C3W cut from the sheet bundle C3 covered with the cover sheet by the cutting line L1 is bound with the adhesive BN applied to a spine BW side of the cutting scrap. As illustrated in FIG. 10B, the unbound side of the cutting scrap C3W is adversely opened. When the cutting scrap C3W in a spreading state illustrated in FIG. 10B is discharged to the cutting scrap containing portion 70, there is a fear in that the cutting scrap C3W may be caught at some midpoint of a discharging passage or may become bulky inside the cutting scrap container 68 to deteriorate a containing efficiency.

[Post-Processing Apparatus C]

As illustrated in FIG. 1, the post-processing apparatus C is connected to the bookbinding apparatus B. The post-processing apparatus C includes the post-processing passage 38 continuing from the cover sheet conveyance passage 34. At least one post-processing device (not shown) such as a stapling unit, a punching unit, or a stamp unit is arranged on the post-processing passage 38. Accordingly, the post-processing apparatus C receives, through the cover sheet conveyance passage 34, sheets having been subjected to image formation, which have been conveyed from the image forming apparatus A, and performs at least one post-processing such as stapling, punching, or stamping on the sheets having been subjected to image formation. Then, the post-processing apparatus C conveys sheets having been subjected to image formation to a discharge tray 37 by the discharge roller pair 38a. The post-processing apparatus C can also discharge the sheets having been subjected to the image formation, which have been conveyed from the image forming apparatus A and are not required to be subjected to such post-processing, to the discharge tray 37 without performing the post-processing.

[Bookbinding Apparatus Control CPU 85]

FIG. 4 is a control block diagram for illustrating the image forming apparatus A and the bookbinding apparatus B. An image forming apparatus control CPU 83 of the image forming apparatus A is connected to an input portion (control panel) 82 and a mode setting portion 84. The bookbinding apparatus control CPU 85 serving as control means of the bookbinding apparatus B calls a bookbinding processing execution program from the ROM 87 and executes each processing step for the bookbinding passage 33 (FIG. 1). The image forming apparatus control CPU 83 and the bookbinding apparatus control CPU 85 may be integrated to be provided in any one of the image forming apparatus A and the bookbinding apparatus B.

The bookbinding apparatus control CPU 85 is configured to receive a post-processing mode instruction signal, a job end signal, sheet size information, other information relating to bookbinding, and a command signal from the image forming apparatus control CPU 83. The bookbinding apparatus control CPU 85 is also configured to transmit information on a bookbinding operation state to the image forming apparatus control CPU 83. A sheet sensor (not shown) configured to detect a sheet (sheet bundle) being conveyed is arranged in each of the carry-in passage 31 (FIG. 1), the bookbinding passage 33, and the cover sheet conveyance passage 34.

The bookbinding apparatus control CPU 85 is configured to receive not only various signals from the image forming apparatus control CPU 83 but also detection signals from the respective sheet sensors to control a “stacking portion controller 85a”, an “adhesive applying portion controller 85b”, a “cover sheet binding portion controller 85c”, a “bundle attitude changing portion controller 85d”, a “pressure portion controller 85e”, a “cutting portion controller 85f”, a “cutting scrap containing portion controller 85g”, and a “containing stacker control 85h”.

[Pressurization Operation of Cover Sheet Binding Portion 60 at Cover Sheet Binding Position F]

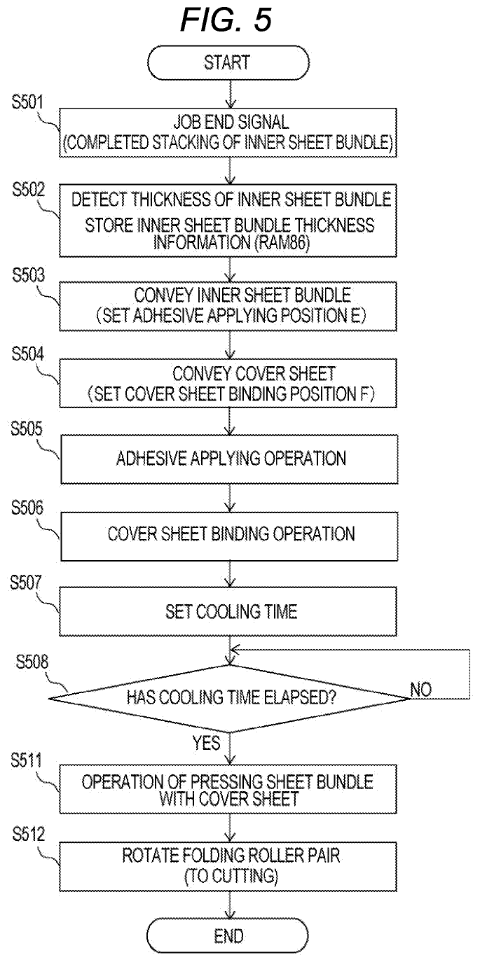

Next, an operation of pressing, by the cover sheet binding portion 60, the inner sheet bundle from the thickness direction at the cover sheet binding position F is described with reference to a flowchart illustrated in FIG. 5.

When the job end signal is received from the image forming apparatus control CPU 83 (Step S501), the bookbinding apparatus control CPU 85 detects the thickness of the inner sheet bundle based on the detection signal received from the slidac sensor Se7 or Th (FIG. 2) (Step S502). The bookbinding apparatus control CPU 85 stores a detected value in the RAM 86 (FIG. 4) (Step S502). Subsequently, the inner sheet bundle aligned as a copy on the stack tray 41 is changed from the horizontal attitude to the vertical attitude, and is moved along the bookbinding passage 33 to reach the adhesive applying position E on the downstream side (Step S503).

The bookbinding apparatus control CPU 85 conveys the cover sheet from the cover sheet conveyance passage 34 (FIG. 2) to the cover sheet binding position F in response to the sheet bundle being set at the adhesive applying position E (Step S504). The cover sheet may be fed from the image forming apparatus A with an image having been formed thereon, or may be fed from the inserter apparatus 26 without an image having been formed thereon. When the cover sheet is fed from the inserter apparatus 26 (FIG. 1), the bookbinding apparatus control CPU 85 actuates the sheet supply portion (not shown) to separate the cover sheets from the sheet feeding tray 26a (FIG. 1) one by one to feed each cover sheet to the cover sheet feeding passage 27.

The cover sheet delivered to the cover sheet feeding passage 27 is conveyed to the carry-in passage 31 by a conveyance roller pair 27a. The bookbinding apparatus control CPU 85 brings the passage switching member 28 to a position in a state illustrated in FIG. 1, and guides the cover sheet to the cover sheet conveyance passage 34. The cover sheet conveyance passage 34 is provided with a registration mechanism 34b for correcting the attitude of the cover sheet. The cover sheet having the attitude corrected by the registration mechanism 34b is conveyed from the registration mechanism 34b by a predetermined distance, and reaches the cover sheet binding position F to be brought to the standstill. Subsequently to the cover sheet feed setting, the bookbinding apparatus control CPU 85 drives the adhesive applying portion 55 to apply the adhesive to the inner sheet bundle set at the adhesive applying position E (Step S505). The adhesive container 56 provided with the applying roll 57 is moved along a lower end edge of the inner sheet bundle, and the adhesive impregnated on a roll surface of the applying roll 57 is applied to one end of the inner sheet bundle.

After the adhesive applying portion 55 (FIG. 2) has completed an adhesive applying operation, the bookbinding apparatus control CPU 85 causes the grip conveyance portion 47 to transfer the inner sheet bundle to the cover sheet binding position F on the downstream side. The cover sheet has already been set at this position, and hence the cover sheet is supported by the abutment plate 61 to be joined to the inner sheet bundle. Subsequently, with the cover sheet and the inner sheet bundle being in abutment with each other, the folding plates 62 push the cover sheet to cause the cover sheet to be bonded to the inner sheet bundle (Step S506). Through the above-mentioned steps, a cover sheet is attached to an inner sheet bundle to form a sheet bundle covered with a cover sheet.

Subsequently, the bookbinding apparatus control CPU 85 determines whether or not to perform the trimming cut. At the same time, the bookbinding apparatus control CPU 85 sets a cooling time required for the adhesive applied to the inner sheet bundle to become solid (solidify) (Step S507). Numerical values are merely reference numerical values, and do not limit the present invention.

This cooling time is set according to a thickness T of the inner sheet bundle. For example, when the thickness of the inner sheet bundle is less than 10 mm, the cooling time is set to about 30 seconds. When the thickness of the inner sheet bundle exceeds 10 mm and is equal to or less than 20 mm, the cooling time is set to about 40 seconds. When the thickness of the inner sheet bundle exceeds 20 mm and is equal to or less than 30 mm, the cooling time is set to about 50 seconds. When the thickness of the inner sheet bundle exceeds 30 mm, the cooling time is set to about 60 seconds. The bookbinding apparatus control CPU 85 reads a data table, which is stored in the RAM 86 in advance based on properties of the adhesive, to set this cooling time according to the bundle thickness of the sheet bundle to be bound.

The end of a cover sheet binding operation is detected by position sensors Se5 and Se6 (FIG. 2) of the folding plates 62a and 62b. The position sensors Se5 and Se6 detect that the folding plates 62a and 62b have been separated from each other after having approached each other and have returned to a waiting position, and transmit an operation completion signal. The bookbinding apparatus control CPU 85 determines that the cover sheet binding operation has been completed by receiving the operation completion signal. The bookbinding apparatus control CPU 85 waits until the cooling time set in Step S507 has elapsed after receiving the operation completion signal. When the cooling time has elapsed (YES in Step S508), the bookbinding apparatus control CPU 85 again brings the folding plates 62a and 62b closer to the sheet bundle covered with the cover sheet to press the sheet bundle covered with the cover sheet from both sides in the thickness direction (Step S511). After that, the image forming apparatus control CPU 83 separates the folding plates 62a and 62b from each other, causes the abutment plate 61 to retreat from the bookbinding passage 33, and at the same time, causes the grip conveyance portion 47 to release the grip of the inner sheet bundle. The sheet bundle covered with the cover sheet is conveyed to the cutting position by the folding roller pair 63. The processing of Step S511 is not always required to be performed.

The sheet bundle covered with the cover sheet falls downward from the cover sheet binding position F to be nipped by the folding roller pair 63. The bookbinding apparatus control CPU 85 rotates the folding roller pair 63 in a discharging direction to deliver the sheet bundle covered with the cover sheet toward the downstream side.

[Control of Cover Sheet Binding Operation Based on Property Information of Cover Sheet]

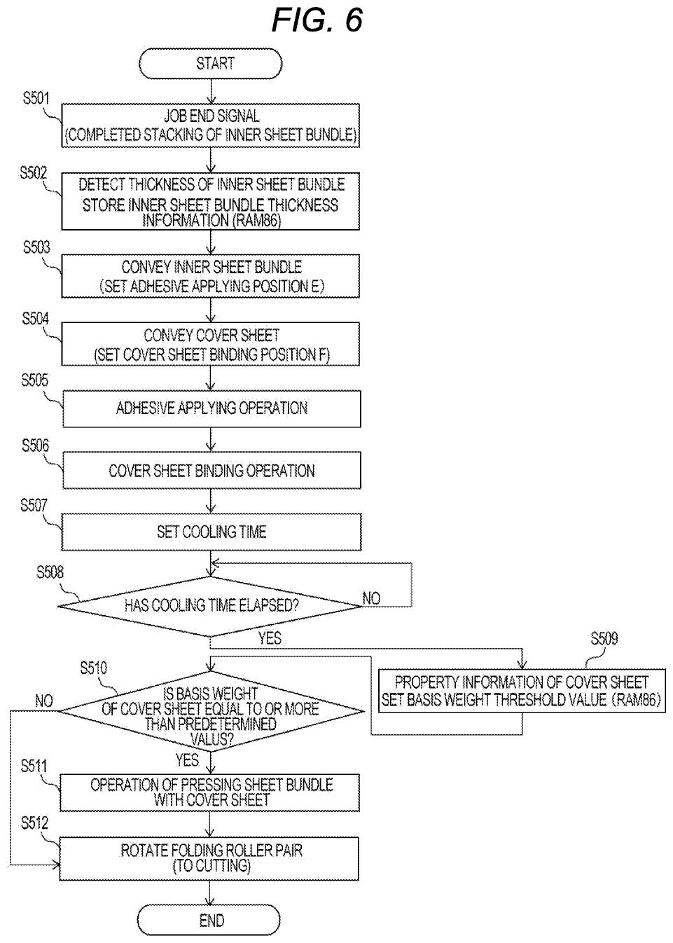

FIG. 6 is a diagram for illustrating a control flow in the case of controlling an operation of pressing the cover sheet based on property information of a sheet to be used as the cover sheet. Step S501 to Step S508, Step S511, and Step S512 illustrated in FIG. 6 are the same as Step S501 to Step S508, Step S511, and Step S512 illustrated in FIG. 5, and hence description thereof is omitted.

In Step S509, the bookbinding apparatus control CPU 85 sets a basis weight threshold value. The bookbinding apparatus control CPU 85 reads the data table stored in the RAM 86 (FIG. 4) in advance to set the basis weight threshold value.

Then, the bookbinding apparatus control CPU 85 compares a basis weight serving as the sheet information of the cover sheet, which has been input to the input portion 82 (FIG. 4) of the image forming apparatus A by the user, against the basis weight threshold value (Step S510). When the basis weight of the cover sheet is equal to or more than the basis weight threshold value (YES in Step S510), the bookbinding apparatus control CPU 85 performs the operation of pressing the cover sheet. When the basis weight of the cover sheet is less than the basis weight threshold value (NO in Step S510), the bookbinding apparatus control CPU 85 rotates a folding roller pair without performing the operation of pressing the cover sheet (Step S512).

The reason why the operation of pressing the cover sheet is not performed when the basis weight of the cover sheet is less than the basis weight threshold value is that a sufficient crease can be created on the cover sheet only by the folding roller pair.

In another case, a plurality of basis weight threshold values may be provided to change the number of pressing operations according to the basis weight of the sheet of the cover sheet. As the basis weight of the sheet of the cover sheet increases, it becomes difficult to create a crease. In view of this, the bookbinding apparatus control CPU 85 increases the number of pressing operations performed by the folding plates 62a and 62b as the basis weight of the sheet of the cover sheet increases. This enables a sufficient crease to be created when a sheet having a large basis weight is used as the cover sheet.

[Pressing Operation of Pressing Member 59y at Cutting Position G]

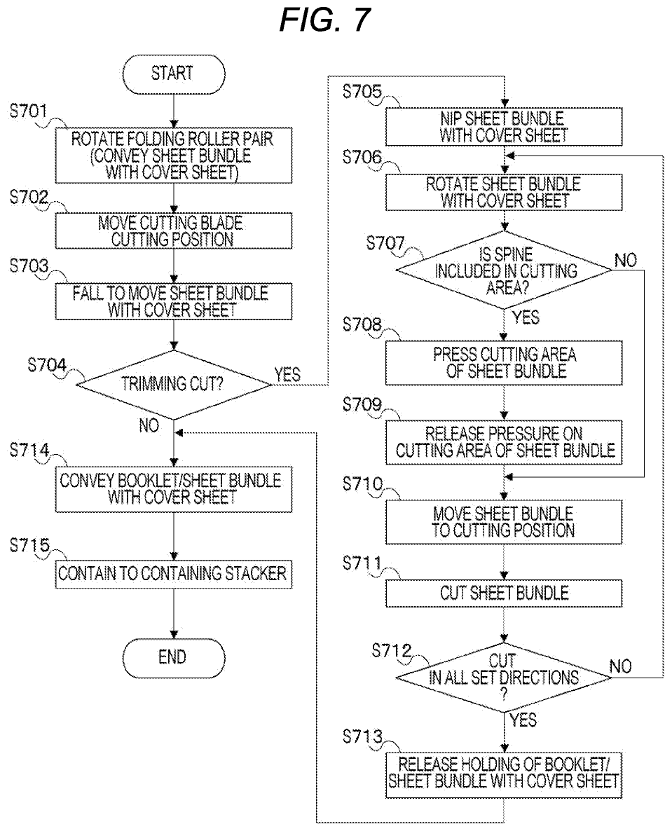

The pressing operation of pressing the sheet bundle covered with the cover sheet from the thickness direction is described with reference to the flowcharts illustrated in FIG. 3 and FIG. 7 and to FIG. 9A. Specifically, the pressing operation is an operation of applying pressure while sandwiching the sheet bundle covered with the cover sheet between the pressing member 59y and the receiving member 58 at the cutting position G.

The bookbinding apparatus control CPU 85 rotates the folding roller pair 63 in the sheet discharging direction in a state in which the sheet bundle covered with the cover sheet is nipped by the folding roller pair 63, and delivers the sheet bundle covered with the cover sheet toward the downstream side (Step S701).

The bookbinding apparatus control CPU 85 rotates the folding roller pair 63, and at the same time, moves the cutting blade 65x from a waiting position Wp to a cutting completion position Cp (Step S702). Then, the sheet bundle covered with the cover sheet falls to be moved onto the cutting blade 65x (Step S703). In the sheet bundle covered with the cover sheet, the edge bound with the adhesive is brought into abutment with the cutting blade 65x to be received by the cutting blade 65x. At this time, the attitude of the sheet bundle C3 covered with the cover sheet is defined by a state in which the edge (spine) bound with the adhesive follows an extending direction of the cutting blade 65x. Subsequently, when the cutting of the cut edge is set (set to the trimming cut) (YES in Step S704), the bookbinding apparatus control CPU 85 causes the sheet bundle covered with the cover sheet to be nipped by the rotation tables 64a and 64b of the bundle attitude changing portion 64 from the thickness direction (Step S705).

Then, the bookbinding apparatus control CPU 85 rotates the rotation tables 64a and 64b of the bundle attitude changing portion 64, which are nipping the sheet bundle covered with the cover sheet, to rotate the sheet bundle covered with the cover sheet in a predetermined direction (Step S706). The bookbinding apparatus control CPU 85 first rotates the rotation tables 64a and 64b so that the side of the cutting line L1 of the sheet bundle C3 covered with the cover sheet faces the cutting position G.

Subsequently, the bookbinding apparatus control CPU 85 determines whether or not the spine C3B is included in a cutting area of the sheet bundle C3 covered with the cover sheet (Step S707). In FIG. 9A, when the cutting is performed along the cutting line L1 and when the cutting is performed along the cutting line L2, the spine C3B is included in the cutting area. Meanwhile, when the cutting is performed by the cutting line L3, the spine C3B is not included in the cutting area.

When the cutting area includes the spine C3B (Yes in Step S707), the procedure advances to Step S708, and when the cutting area does not include the spine C3B (No in Step S707), the procedure advances to Step S710.

When the cutting area includes the spine C3B (Yes in Step S707), the bookbinding apparatus control CPU 85 drives the elevation motor MS to move the sheet bundle C3 covered with the cover sheet and presses a pressed area C3P (Step S708). That is, the bookbinding apparatus control CPU 85 uses the pressure portion 59 to press connection areas connected to the spine C3B, which are respectively provided on the first surface and the second surface of the sheet bundle C3 covered with the cover sheet. In other words, the pressure portion 59 presses portions (connection areas) that are a part of the first surface and a part of the second surface and are continuous with the spine. Then, those connection areas serve as the pressed area C3P. A specific description thereof is given.

First, the bookbinding apparatus control CPU 85 moves the sheet bundle C3 covered with the cover sheet to a position at which the pressed area C3P is to be pressed by the pressing member 59y. This position alignment is set based on a signal received from a sheet lower end detecting sensor (not shown). After a lower end detecting sensor has detected a leading end of the sheet bundle covered with the cover sheet in the gravity direction, the bookbinding apparatus control CPU 85 drives the elevation motor MS for a predetermined time. Subsequently, the bookbinding apparatus control CPU 85 drives the cut edge pressing unit 59b to press the pressed area C3P with a force of from about 2 kN to about 4 kN.

The pressed area C3P to be pressed in Step S708 is set to include the spine BW of the cutting scrap to be cut in a later step in the spine C3B of the sheet bundle C3 covered with the cover sheet. In other words, the pressed area C3P is set to connect to the spine BW to be the cutting scrap in the spine C3B.

Subsequently, the bookbinding apparatus control CPU 85 releases the pressure being applied to the sheet bundle C3 covered with the cover sheet by the cut edge pressing unit 59b (Step S709).

Subsequently, the bookbinding apparatus control CPU 85 drives to rotate the elevation motor MS to move the sheet bundle C3 covered with the cover sheet, and to align the cutting line L1 with the cutting position G of the cutting portion 65 (Step S710).

After that, the bookbinding apparatus control CPU 85 uses the cut edge pressing unit 59b to press an area other than the cutting area of the sheet bundle C3 covered with the cover sheet, and uses a cutter motor Mc to move the cutting blade unit 65a from the waiting position Wp to the cutting completion position Cp. When the cutting blade unit 65a has moved to the cutting completion position Cp, the cutting scrap C3W is separated from the sheet bundle covered with the cover sheet (Step S711). That is, the bookbinding apparatus control CPU 85 uses the pressure portion 59 to press the pressed area C3P, and then uses the cutting portion 65 to cut the sheet bundle C3 covered with the cover sheet so that the pressed area C3P is included in the cutting scrap C3W. At this time, the cutting portion 65 is used to cut the sheet bundle C3 covered with the cover sheet while causing the pressure portion 59 to press the area other than the area to be the cutting scrap of the sheet bundle C3 covered with the cover sheet.

When the other edge of the sheet bundle covered with the cover sheet is also cut (NO in Step S712), the procedure returns to Step S706, and the bookbinding apparatus control CPU 85 rotates the sheet bundle C3 covered with the cover sheet so that a cutting line that has not been cut yet faces the cutting position G. When the cutting has been finished for all the cutting lines (YES in Step S712), the sheet bundle covered with the cover sheet becomes a booklet. Then, the bookbinding apparatus control CPU 85 releases the holding of the booklet by the bundle attitude changing portion 64 (Step S713). The booklet falls on the booklet discharging roller pair 66, and is conveyed by the booklet discharging roller pair 66 being driven (Step S714) so as to be contained in the containing stacker 67 (Step S714).

When the trimming cut is not performed (No in Step S704), the sheet bundle covered with the cover sheet is conveyed as it is (Step S714) to be contained in the containing stacker 67 (Step S715).

In this manner, in addition to the above-mentioned pressing performed by the folding plates 62 (62r and 62r) (processing of Step S511 illustrated in FIG. 5), the pressed area C3P is pressed by the cut edge pressing unit 59b also before the sheet bundle C3 covered with the cover sheet is cut. This prevents the cover sheet of the cutting scrap C3W from being opened with a lapse of time after the binding is performed. Then, it is possible to prevent the cutting scrap C3W from being caught at some midpoint of falling into the cutting scrap container 68 or becoming bulky inside the cutting scrap container 68 to deteriorate the containing efficiency of the cutting scrap C3W.

### Second Embodiment

A second embodiment of the present invention is described. A basic configuration of the second embodiment is the same as that of the first embodiment, and hence the following description of the second embodiment is given mainly to a part different from the first embodiment.

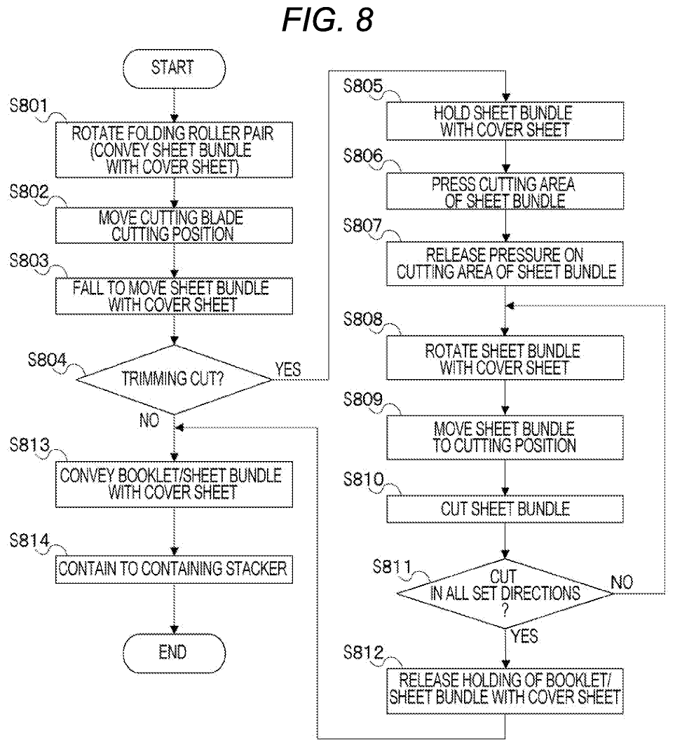

The second embodiment of the present invention is configured so that a pressed area of the sheet bundle C3 covered with the cover sheet is pressed by one operation. A pressing operation to be performed in the second embodiment is described with reference to a flowchart illustrated in FIG. 8 and to FIG. 9B, FIG. 10A, and FIG. 10B.

When trimming is to be performed (Yes in Step S804), the same operations as Step 701 to Step 705 illustrated in FIG. 7 are performed in Step S801 to Step S805.

Subsequently, the bookbinding apparatus control CPU 85 presses the sheet bundle C3 covered with the cover sheet, which is held by the rotation tables 64a and 64b of the bundle attitude changing portion 64, by sandwiching the sheet bundle C3 by the pressing member 59y and the receiving member 58 (Step S806). At this time, the sheet bundle C3 covered with the cover sheet is in a state in which the spine C3B bound with the adhesive and the cutting blade 65x are in abutment with each other. The pressing member 59y and the receiving member 58 have a length sufficient to press the entire spine C3B, and press the pressed area C3P of the sheet bundle C3 covered with the cover sheet in FIG. 9B. The pressed area C3P illustrated in FIG. 9B includes the spine BW of the cutting scrap to be cut at the cutting lines L1 and L2 in a later step. In other words, the cutting scrap and a remaining part of the sheet bundle C3 covered with the cover sheet from which the cutting scrap has been removed each include the pressed area C3P.

Depending on a positional relationship between the cutting blade 65x and the pressing member 59y, the spine BW of the cutting scrap may not be included in the pressed area C3P. In that case, the bookbinding apparatus control CPU 85 presses the pressed area C3P after causing the bundle attitude changing portion 64 to move the position of the sheet bundle C3 covered with the cover sheet so that the spine BW of the cutting scrap is included in the pressed area C3P.

The subsequent steps are the same as those in the first embodiment. That is, the bookbinding apparatus control CPU 85 releases the pressure on the sheet bundle C3 covered with the cover sheet (Step S807), rotates the edge of the sheet bundle C3 covered with the cover sheet at which the sheet bundle C3 is to be cut toward the cutting portion 65 (Step S808), and moves the sheet bundle C3 covered with the cover sheet to the cutting position (Step S809) to perform the cutting (Step S810). When the cutting of required parts has been finished (Step S811), the completed booklet is contained in a containing stacker (Step S812, Step S813, and Step S814).

According to this embodiment, the pressed area C3P of the sheet bundle C3 covered with the cover sheet is pressed by one pressing operation, and hence a time required for the trimming can be shortened in suppressing the opening of the cutting scrap C3W.

### Other Embodiments

In the first embodiment and the second embodiment, modes in which the pressed area C3P is differently arranged in the sheet bundle C3 covered with the cover sheet have been described, but embodiments of the present invention are not limited thereto. The effects of the present invention can be produced by using the cutting means to cut the cutting scrap including the spine of the sheet bundle covered with the cover sheet after the control means has caused the pressure means to press only an overlapping area of the pressed area in the first embodiment and the pressed area in the second embodiment.

Further, when the bookbinding apparatus control CPU 85 causes the pressure portion 59 to press the cutting area of the sheet bundle, a pressure force may be changed according to the thickness of the sheet bundle. In this case, the pressure force of the pressure portion 59 is increased as the sheet bundle becomes thicker. That is, the bookbinding apparatus control CPU 85 sets a force to be applied by the pressure portion 59 to press the sheet bundle so that the force to be applied when the thickness of the sheet bundle is large becomes larger than the force to be applied when the thickness of the sheet bundle is small. Accordingly, it is possible to prevent the cutting scrap from being opened irrespective of the thickness of the sheet bundle.

The present invention is not limited to the embodiments described above, and various changes and modifications can be made without departing from the spirit and scope of the present invention. The following claims are appended hereto in order to make the scope of the present invention public.

The present application claims priority based on Japanese Patent Application No. 2018-081833 filed on Apr. 20, 2018 and Japanese Patent Application No. 2019-075956 filed on Apr. 11, 2019, and the entire contents thereof are incorporated herein by reference.

### REFERENCE SIGNS LIST

A: image forming apparatus, B: bookbinding apparatus, C: post-processing apparatus, D: sheet bundle cutting apparatus, E: adhesive applying position, F: cover sheet binding position, G: cutting position, J: image forming system, C1: inner sheet, C2: cover sheet, C3: sheet bundle covered with cover sheet, C3B: spine of sheet bundle covered with cover sheet, C3P: pressed area, C3W: cutting scrap, BN: adhesive, BW: spine of cutting scrap, 32: inner sheet conveyance passage, 33: bookbinding passage, 34: cover sheet conveyance passage, 55: adhesive applying portion (adhesive applying means), 58: receiving member, 59: pressure portion (pressure means), 59y: pressing member, 60: cover sheet binding portion, 64: bundle attitude changing portion (moving/rotating means), 64a, 64b: rotation table (holding means, rotating means), 64x: unit frame (moving means), 65: cutting portion (cutting means), 65x: cutting blade (position alignment means), 66: booklet discharging roller pair, 67: containing stacker, 68: cutting scrap container, 69: sweeper portion, 70: cutting scrap containing portion (cutting scrap containing means), 83: image forming apparatus control CPU, 85: bookbinding apparatus control CPU (control means)

1. A sheet bundle cutting apparatus configured to cut a sheet bundle including a bound spine, the sheet bundle cutting apparatus comprising:
a pressing unit configured to press the sheet bundle in a thickness direction of the sheet bundle while sandwiching a first surface and a second surface of the sheet bundle;
a cutting unit configured to cut, from the sheet bundle, a cutting scrap including a part of the spine;
a controlling unit configured to control the pressing unit and the cutting unit, the controlling unit being configured to cause the pressing unit to press connection areas connected to the spine, which are respectively provided on the first surface and the second surface, and then cause the cutting unit to cut the sheet bundle so that the cutting scrap includes a pressed area pressed by the pressing unit; and
a containing unit configured to contain the cutting scrap.

2. The sheet bundle cutting apparatus according to claim 1, wherein the cutting scrap and a remaining part of the sheet bundle from which the cutting scrap has been removed each include the pressed area.

3. The sheet bundle cutting apparatus according to claim 1, wherein the cutting unit includes a cutting blade, and
wherein the pressing unit is configured to press the pressed area in a state in which the spine and the cutting blade are in abutment with each other.

4. The sheet bundle cutting apparatus according to claim 1, wherein the controlling unit is configured to cause the cutting unit to cut the sheet bundle while causing the pressing unit to press an area other than an area to be the cutting scrap of the sheet bundle.

5. The sheet bundle cutting apparatus according to claim 1, wherein the controlling unit is configured to control the pressing unit so that a force to be applied by the pressing unit to press the sheet bundle when a thickness of the sheet bundle is large becomes larger than a force to be applied by the pressing unit to press the sheet bundle when the thickness of the sheet bundle is small.

6. The sheet bundle cutting apparatus according to claim 1, wherein the sheet bundle has the spine bound with an adhesive.

7. A bookbinding apparatus comprising:
a binding apparatus configured to bind a sheet bundle; and
a sheet bundle cutting apparatus, which is configured to cut the sheet bundle bound by the binding apparatus and including a bound spine, the sheet bundle cutting apparatus comprising:
a pressing unit configured to press the sheet bundle in a thickness direction of the sheet bundle while sandwiching a first surface and a second surface of the sheet bundle;
a cutting unit configured to cut, from the sheet bundle, a cutting scrap including a part of the spine;
a controlling unit configured to control the pressing unit and the cutting unit, the controlling unit being configured to cause the pressing unit to press connection areas connected to the spine, which are respectively provided on the first surface and the second surface, and then cause the cutting unit to cut the sheet bundle so that the cutting scrap includes a pressed area pressed by the pressing unit; and
a containing unit configured to contain the cutting scrap.
